(19) United States
(12) Patent Application Publication
(10) Pub. No.: US 2010/0088399 A1
(43) Pub. Date: Apr. 8, 2010

(54) Enterprise security setup with prequalified and authenticated peer group enabled for secure DHCP and secure ARP/RARP

(76) Inventor: Yoel Gluck, San Francisco, CA (US)

Correspondence Address: YOEL GLUCK, C/O NIF/T. LLC, 19160 BAINTER AVE, LOS GATOS, CA, 95030, US

(21) Appl. No.: 12/585,718

(22) Filed: Sep. 23, 2009

Related U.S. Application Data
(60) Provisional application No. 61/195,098, filed on Oct. 3, 2008.
(60) Provisional application No. 61/195,095, filed on Oct. 3, 2008.

(51) Int. Cl. G06F 15/177

(52) U.S. Cl. 709/221

(57) ABSTRACT

The method enables prevention of attacks on the network using layer-2 to layer-4 internet protocols. A secure local area network (LAN) is established having a secure peer group (SPG) of member entities with each member entity having its media access control (MAC) address locked to its own identity. A secure server within the LAN is configured as administrative and dynamic host configuration protocol (DHCP) server enabled to issue IP addresses. When using DHCP, address resolution protocol (ARP), and reverse address resolution protocol (RARP), the identity of the requesting entity is verified and entity is confirmed as legitimate. Data sent during transactions is encrypted using the public key of the receiving entity. These steps enable verified and secure establishment of IP to MAC binding during DHCP and ARP, and an enabler for secure connectivity between members of the SPG for eliminating attacks on the secure LAN.

### CROSS REFERENCE TO RELATED APPLICATION

This application claims the benefit of U.S. Provisional Patent Application No. 61/195,098 filed on Oct. 3, 2008, and is further related to a co-pending provisional patent application 61/195,095 filed on Oct. 3, 2008.

### TECHNICAL FIELD

The invention relates to improving the security of networks and specifically as means for providing security to local area networks in order to reduce vulnerability to attacks using lower level protocols.

### BACKGROUND OF THE INVENTION

Network security is a major concern due to the rapid growth of use of the Internet for all applications including those requiring high security like financial transactions. Though there are several ways and programs for providing security in application, transport, or network layers of a network, there are still too many points of vulnerability in the network. One area of such vulnerability is the data link layer, also known as Layer 2, where security has not been adequately addressed in the past. Layer 2 is the layer that enables interoperability and interconnectivity of networks. Any real vulnerability in the Layer 2, which allows attacks, is not easily detected today by the upper layers and hence can be a major security concern for the user.

Local area networks (LANs) had been considered safe till very recently and hence little effort at securing the LAN were made. A typical LAN comprises one or more domains which are data link layer domains called Layer 2 domains. A LAN is connected to the internet by routers. Within each LAN, traffic is forwarded based on media access control (MAC) addresses. LANs typically use switches to connect between entities within a LAN. Switches are also used to link multiple Layer 2 domains within a LAN. Switches can also be used to link two or more LANs together. Internet traffic is routed by routers using internet protocol (IP) addresses or other network layer addresses for transport through the Internet cloud. Within the Internet cloud the connectivity of the routed path is dynamic and routing takes place based on available resources and paths. In the LAN, on the other hand, the traffic is routed based on the MAC address of individual entities using IP to MAC address linkage and MAC address to port linkages available at the switches and router.

Typically Ethernet devices have unique MAC addresses assigned by a central authority to ensure that no two devices have the same MAC address. Because source MAC address information is inserted into Ethernet frames during communication by the Ethernet devices, the source address in an Ethernet frame had been considered accurate and difficult to fake. Since in theory Ethernet MAC addresses are unique, at least on the same Layer 2 network, and potentially globally, any entity on a Layer 2 network can address any other entity on the network by using the MAC address assigned to the entity being addressed.

Layer 2 forwarding tables are used to connect to and send data between entities in the LAN. The Layer 2 forwarding table is normally created from header information received in Ethernet frames. This is done by storing the MAC address obtained from an Ethernet frame in a Layer 2 forwarding table along with information identifying the port on which the frame including the header was received. Frames directed to the stored MAC address will be output via the port indicated in the Layer 2 forwarding table. Since the information in the Layer 2 forwarding table is obtained from Ethernet Frame headers it was considered to be reliable.

In order to communicate over an IP based network, an entity on an Ethernet LAN is required to first obtain an IP address. This has to be received from a dynamic host configuration protocol (DHCP) server. The DHCP server can be within or outside the LAN. A typical request for IP address assumes that the request has to be transmitted through the IP cloud. To obtain the IP address, the entity within a LAN sends an IP address request message to a router in an Ethernet frame. In response to the request, the router populates the Layer 2 forwarding table with the MAC information obtained from the frame's header. In addition, the router, acts as a proxy for the requesting entity, and initiates a DHCP communications session between a DHCP server and the requesting entity so that it can have an IP address assigned to it.

When an IP address is requested by an entity the MAC address in the header of the frame sent by the entity is not forwarded to the DHCP server. Rather, only a MAC address enclosed within the body of the information is sent. This MAC address is easy to modify and therefore is a known weaknesses of the system. The transmitted MAC address, included in the data field of an Ethernet frame, may be faked. The DHCP server will assign an IP address based on the communicated MAC address. It also stores the assigned IP address, associated MAC address and lease time information in a DHCP server database. The assigned IP address is communicated to the requesting entity, along with lease time or duration information, by way of the router. Hence a requesting entity can falsify its MAC address, linked to the assigned IP address, stored in the data base of the DHCP server. By using the MAC address of an entity within a LAN the attacking entity is able to receive and falsify information going to and coming from the real owner of the MAC address.

In existing systems, when a router connected to a LAN receives a message with an IP address which is not already in its address resolution table, it will broadcast an address resolution protocol (ARP) message over the LAN asking for the entity which owns the IP address to respond and identify itself. Normally, the entity to which the IP address is assigned will respond to the ARP message with its true MAC address. The information from the ARP message response is used to populate and update the router's address resolution table thereby linking the IP address and the MAC address of the responding entity with the port where the response was received. Reverse address resolution request protocol (RARP) is a protocol by which a physical machine in a local area network can request to learn its IP address from a server's, routers cache. This operates the same way as the ARP but in reverse. It is easy to falsify and corrupt an address resolution table by using ARP and RARP and a faked MAC address. In such a case the updated address resolution table of the router will end up being inconsistent with the DHCP server's database enabling attacks on the network.

Recently the attacks on the LANs have become a matter of concern, mainly due to attacks in the IP over Ethernet (layer 2) connectivity which is today the weakest link in the security chain within the LAN. This type of attack typically happens in the case where an attacker already has access to one entity within the LAN. The attacker then attacks the network traffic by presenting itself as the owner of different MAC addresses in the LAN to divert traffic to itself. The attacker can then establish access to sniff/modify network traffic of other entities within the LAN.

It would therefore be advantageous to have a way of securing the LAN network by ensuring that the IP address requests are made in a secure fashion, and the IP addresses that are provided to the entities in the network are linked to their identity and MAC addresses in a verifiable way. It would be further advantageous to have the capability for ARP and RARP requestors and responders to be verified and authenticated as the owners of their respective MAC addresses.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a diagram showing an exemplary and non limiting secure LAN of the current invention

FIG. 2 is a typical flow diagram of the secure and authenticated DHCP operation

FIG. 3 is a typical flow diagram of the secure and authenticated ARP operation

FIG. 4 is a typical mutual authentication process sequence for both DHCP and ARP processes

### DETAILED DESCRIPTION OF THE INVENTION

The method enables prevention of attacks on the network using layer-2 to layer-4 internet protocols. A secure local area network (LAN) is established having a secure peer group (SPG) of member entities with each member entity having its media access control (MAC) address locked to its own identity. A secure server within the LAN is configured as administrative and dynamic host configuration protocol (DHCP) server enabled to issue IP addresses. When using DHCP, address resolution protocol (ARP), and reverse address resolution protocol (RARP), the identity of the requesting entity is verified and entity is confirmed as legitimate. Data sent during transactions is encrypted using the public key of the receiving entity. These steps enable verified and secure establishment of IP to MAC binding during DHCP and ARP, and an enabler for secure connectivity between members of the SPG for eliminating attacks on the secure LAN.

A method implemented at various nodes of a network to prevent or limit attacks on the network that include attacks over layer-2 to layer-4 is disclosed. As a first step in the process a SPG is established. For this each member entity of the SPG is given a unique identification that is backed by having the entity's identity locked to its MAC address. This locking of the identity of each entity to its MAC address and establishment of the SPG within a LAN is described in the co-applied for, provisional patent application No. 61/195,095, “A Secure Peer Group Network and Method Thereof by Locking a MAC Address to an identity of an Entity at Physical Layer”, assigned to common assignee, and which is incorporated herein by reference for all that it contains. During the establishment of the SPG, the identity of an entity is defined by use of, e.g., at least a public key of that entity. This public key is one from a pair of public and private keys generated using the public key infrastructure (PKI).

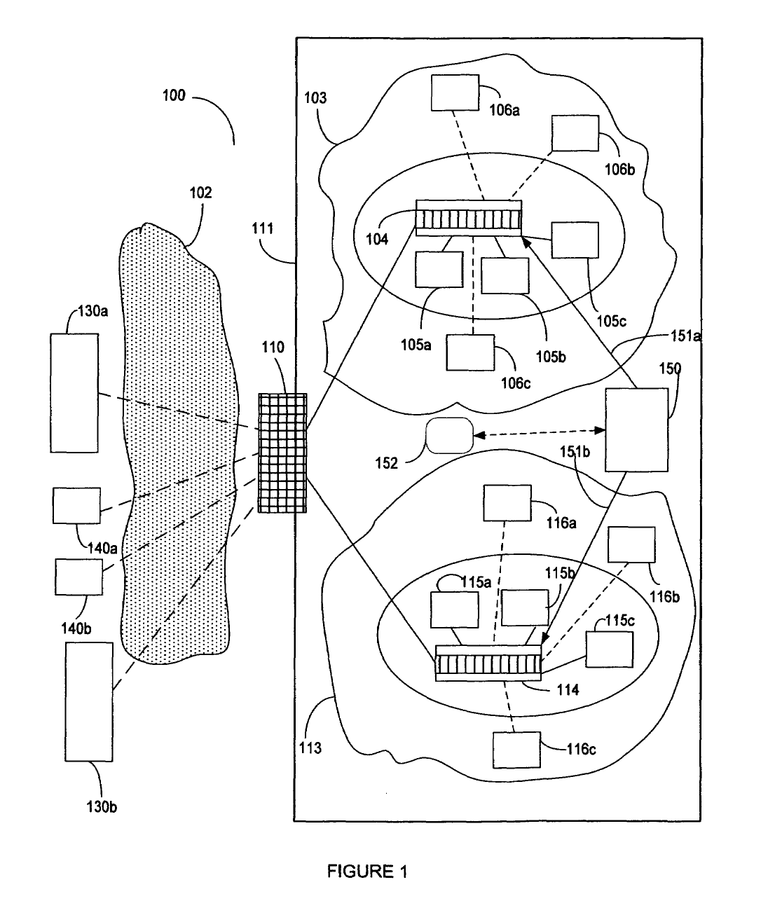

FIG. 1 shows an exemplary and non-limiting network 100 that includes a local area network. In order to configure the LAN 111, a secure administrative server 150, also referred to herein as a secure server, which is also a secure dynamic host configuration protocol (DHCP) server, is provided with the security and group policies for a peer group. The entities 105, e.g., 105a to 105c, are connected by wire and entities 106, e.g., 106a to 106c, are connected by wireless to switch 104. Entities 115, e.g., 115a to 115c, are connected by wire and the entities 116, e.g., 116a to 116c, are connected by wireless to switch 114. The two switches 104 and 114 are part of the LAN 111. The secure server 150 with a storage database 152 is used as the local secure DHCP server for the LAN 111. The LAN 111 is connected to the internet by the router 110. The entities 130, e.g., 130a and 130b, and 140, e.g., 140a and 140b, are connected to the LAN via the router 110 from outside the perimeter of the LAN 111.

In an exemplary and non-limiting implementation of the secure DHCP process for a member entity of the SPG to request and receive an IP address is described. Once the SPG is established and the members are accepted, the secure server 150 provides its root certificate which includes at least its public key to all the members of the SPG.

Before establishing connection, and using network protocols such as DHCP, the secure server 150 and any requesting member entity, e.g., 105a have to verify and authenticate each other. The server is verified using its root certificate. The SPG membership of the requesting entity, e.g., 105a, is verified using its identification, public key and MAC address. The identification and MAC address are checked against the stored identity locked to the MAC address in the secure server's data base 152 for verification. This ensures that the connections are trustworthy and any received data packets are authenticated as being from the member entity, e.g., 105a. Unauthenticated packets may be discarded by the secure server.

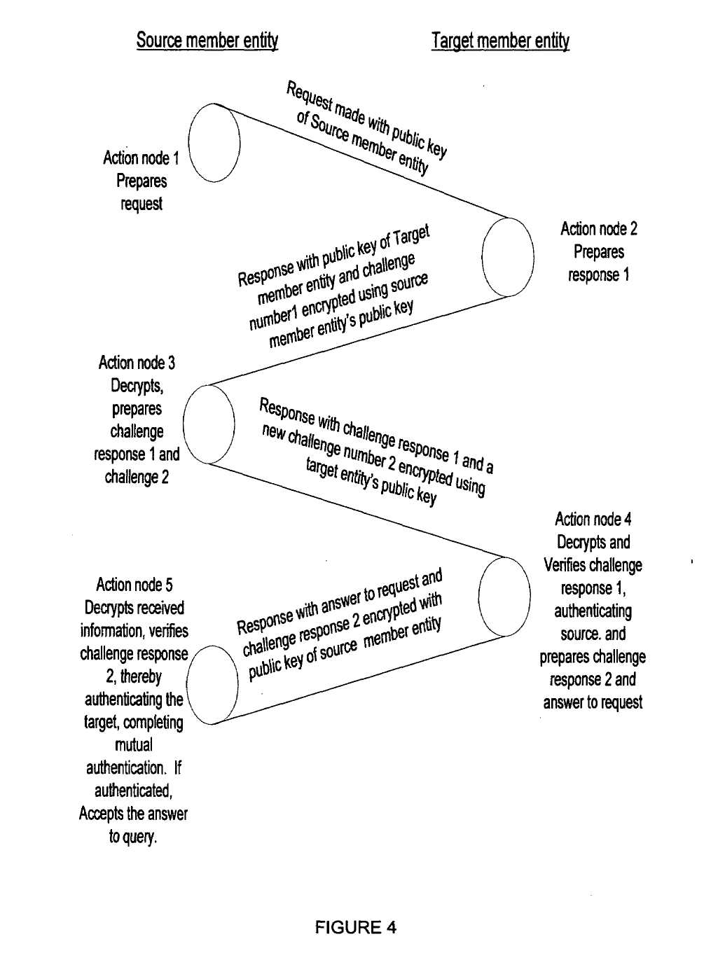

FIG. 4 shows an exemplary and non-limiting sequence of interactions for the process of verification and mutual authentication between a source member entity and target member entity. This is done using challenge number and challenge response encrypted using public key from the pair of keys already generated using public key infrastructure (PKI) by the source and target member entities. In a typical verification and authentication sequence (a) the source member entity sends a request to the target member entity with at least its public key enclosed. (b) The target member entity receives the information and sends its information back to the source member entity, with at least its public key and a challenge number, encrypted using the public key of the source member entity. (c) The information is decrypted by the source member entity using its private key and the source entity responds with at least its public key, challenge response and a challenge number of its own, encrypted using the public key of the target entity. The target member entity decrypts the received response using its private key and verifies the challenge response for correctness. The correct response to the challenge number authenticates the source member entity to the target. (d) The target entity then prepares the answer to the original request. It then responds to the source member entity with the response to the challenge number from the source member entity, its public key and the answer to the original request, all encrypted using the source member entity's public key. This when received by the source member entity is decrypted using the private key of the source member entity. The challenge response is verified for correctness, there by authenticating the target entity before accepting any answer to the request received.

The typical and non-limiting sequence of steps for a DHCP process whereby a member entity is allotted an internet protocol address by the secure server acting also as the DHCP server are as follows:

When a entity, say, 105a, that is a member of the SPG and part of the secure LAN 111, requests an internet protocol (IP) address, that request goes to the local secure server 150. The Secure server 150 is the secure administrative server and the secure DHCP server within the LAN 111 and a member of the SPG. The request from the member entity, e.g., 105a is done with encryption using the public key of the secure server 150 from its root certificate. The request includes the identification information of the requesting entity, e.g., 105a, and a challenge number to prevent replay attacks, in addition to any information needed for establishing an IP address for that entity. Since the request and information are all encrypted using the public key of the secure server 150, the secure server 150 is the only entity that can decrypt the message and extract the information.

The secure server 150 decrypts the information received and verifies the SPG membership of the requesting entity, e.g., 105a, using its identification and MAC address. For this the identification and MAC address are checked against the stored identity linked to the MAC address in the secure server's data base 152.

The secure server 150 then sends a challenge response and a new challenge number of its own with the root certificate of the administrative/DHCP server 150, encrypted using the member entity's, e.g., 105a, public key.

The member entity, e.g., 105a, decrypts the information and checks and verifies the challenge response authenticating the secure server.

The member entity, e.g., 105a, then sends a response to the challenge from the secure server with its identification, again with a new challenge number encrypted using the secure server's 150's public key. This information is sent to the secure server 150.

The secure server 150 decrypts the information received and checks and verifies the challenge response, authenticating the member entity, e.g., 105a.

The secure server uses the verified information to issue the necessary IP address and establish IP to MAC binding for the requesting entity, e.g., 105a. An entity specific certificate (ESC) is prepared by the secure server comprising at least the IP address that has been bound to the MAC address and identification, the identification having at least the public key of the member entity, e.g., 105a, The ESC, and the challenge response encrypted using the member entity's public key is sent to the member entity, e.g., 105a.

The member entity, e.g., 105a, decrypts the packets received and verifies the identity of the sender as the secure server 150 as well as the challenge response before accepting the ESC including the IP address assigned to it thereby completing the DHCP process.

This process of mutual authentication limits and/or eliminates the ability of any other entity planning an attack to falsify its MAC address. The use of the SPG hence allows establishment of secure communication between members of the SPG in the LAN 111 and the secure server 150 during the DHCP process for IP address allocation to the entities that are members of the SPG.

A second exemplary and non-limiting implementation is in the case where the entities do not have the root certificate of the secure server 150 also acting as a secure DHCP and administrative server. To get the IP address the member entity, e.g., 105a, sends DHCP discover packets which are responded to by one or more DHCP servers, including the secure server 150 of the LAN 111. The response from the secure server 150 will include its root certificate containing at least the public key of the secure server 150.

The member entity, e.g., 105a, decides to which responding DHCP server to connect to, based on the configuration and policies of the SPG and the LAN 111, which may include verification of the received root certificate. The member entity, e.g., 105a, sends a DHCP request to the secure server 150 with its identification and a challenge number encrypted using the public key of the secure server 150. The secure server 150, on receipt of the request, decrypts it and verifies the member entity, e.g., 105a, as a valid entity within the LAN 111 and a member of the SPG. This is done by checking the MAC address of the member entity, e.g., 105a against the stored MAC addresses locked to identity of members of SPG, in the data base 152 of the secure server 150. If validity of the entity in the LAN 111 is established, the secure server 150 responds with a challenge response and a challenge number encrypted using the public key of the member entity, e.g., 105a. The member entity, e.g., 105a, decrypts the response received and checks the challenge response to authenticate the secure server 150. The member entity, e.g., 150a, then responds back with a challenge response and a challenge number encrypted using the secure server's 150 public key. The security server decrypts the response and verifies the challenge response thereby authenticating the member entity, e.g., 150a. The secure server 150 then issues an IP address depending on the policies associated with the member entity, e.g., 105a, links it to the MAC address of the member entity, e.g., 105a, and generates an entity specific certificate (ESC). The ESC for the member entity, e.g., 105a, includes at least the IP address of the member entity, e.g., 105a, linked to its MAC address, and its public key. The generated ESC is sent, by the secure server 150, to the member entity, e.g., 105a, with the challenge response encrypted using the member entity's public key. The member entity, e.g., 105a, decrypts the received input checks the challenge response and if verified accepts the IP address thereby completing the secure DHCP process.

As a special instance, a static IP used within the LAN can be issued at the point when the SPG formation takes place as part of the identity of the member entities within the SPG. Use of static IP therefore reduces the need for establishing an additional secure DHCP process within the LAN 111.

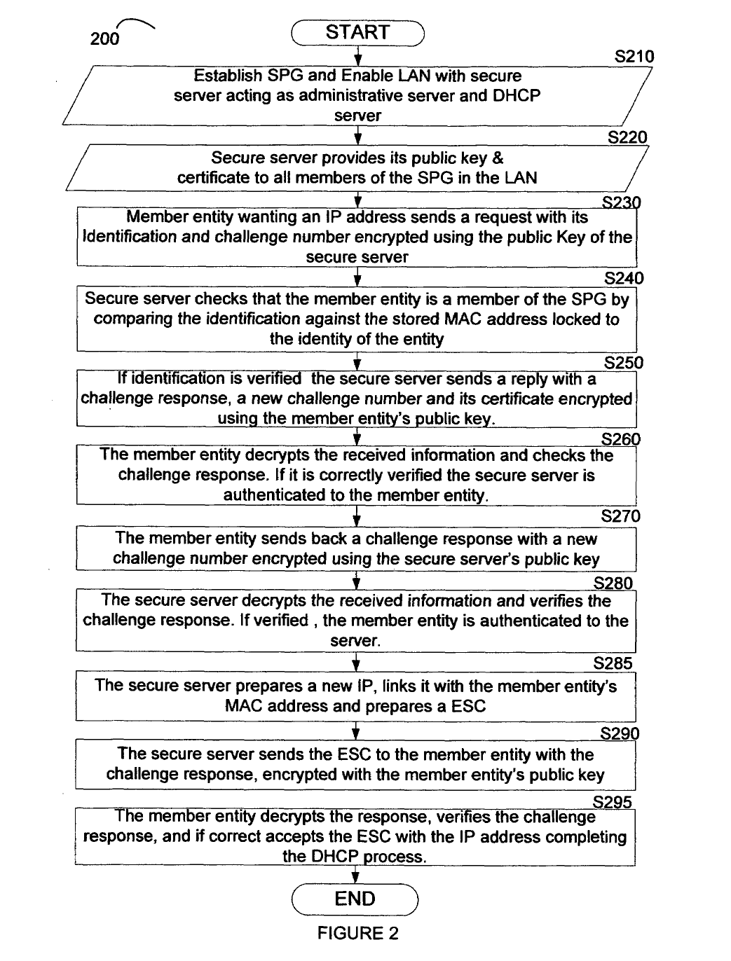

The establishing of the DHCP process for receipt of IP addresses in accordance with the principles of the disclosed invention between pre-qualified peers of the SPG in the LAN has the following exemplary and non-limiting steps shown in the flowchart 200 in FIG. 2:
The SPG is established and the LAN 111 is enabled with secure server 150 that also acts as the secure administrative server and secure DHCP server (S210);
The secure server 150 provides its public key as part of its root certificate to all member entities of the SPG as part of the configuration process for the LAN 111 (S220);
A member entity, e.g., 105a, sends a request to the secure server 150 for an IP address, where the request includes a challenge number, and the member entity's identification containing at least its MAC address and requesting entity's public key, encrypted using the secure server's public key (S230);
The secure server 150 decrypts the request using its private key and verifies the eligibility of the requesting member entity, e.g., 105a, as being eligible to be in the LAN and is a member of the SPG. This is achieved by comparing the information received, to the stored locked MAC address to the identity of the member entity, e.g., 105a, available in the database 152 of the secure server 150 (S240);
If the member entity, e.g., 105a, is verified as a legitimate member of the SPG, based on the policies established for the LAN 111, the secure server sends a challenge response with a challenge number of its own and its certificate to the member entity, e.g., 105a, encrypted using the member entity's e.g., 105a, public key (S250);
The member entity, e.g., 105a, decrypts the received response using its private key and verifies the challenge response. If correct it authenticates the secure server to the member entity, e.g., 105a. (S260)
The member entity responds to the secure server 150, with a response to the challenge number from secure server 150, with a second challenge number of its own encrypted using the secure server's public key (S270)
The secure server 150 receives the response decrypts it and verifies the challenge response. If correct the member entity, e.g., 105a, is authenticated to the secure server 150; (S280);
The secure server generates an IP address using DHCP process. This IP address is linked to the MAC address of the member entity, e.g., 105a, to generate an ESC (S285);
The secure server 150 sends the generated ESC with the response to challenge number to the member entity, e.g., 105a, encrypted using that member entity's public key (S290);
The member entity, e.g., 105a, decrypts the response, checks and verifies the authenticity of the data by checking the challenge response. If correct it accepts the ESC with its IP address linked to its MAC address completing the DHCP process (S295);

ARP and RARP processes are used to identify and link the IP address of individual entities in a LAN 111 with their MAC addresses for establishing connectivity. If a member entity wants to send a packet to another member entity whose IP address is known but the MAC address is unknown, then an ARP request is sent out. In order to prevent entities from responding with false MAC addresses, creating attack possibilities in the LAN 111, it is necessary to use secure ARP and RARP processes. These methods for validation and authentication of the member entities involved in the ARP and RARP processes are disclosed in the current application.

Since the ARP and RARP protocols are similar because the ARP process is for finding the MAC address of an unknown entity who owns an IP address and the RARP process is for finding the IP address of an unknown entity who owns a MAC address. Hence only the exemplary and non-limiting ARP process is discussed further. In both cases the aim is to link the MAC address of the target entity to the IP address of the target entity and update the address lists of the source and target entities in a secure fashion.

In an exemplary and non-limiting implementation of the disclosed invention secure ARP process is used when a member entity, e.g.,106a, require to find the MAC address belonging to an IP address of a second member entity, e.g., 105b. In a LAN 111, the source member entity, e.g., 106a, broadcasts an ARP request with its ESC information. As a response to the ARP request the target member entity e.g. 105b sends a modified ARP response with its ESC and a challenge number encrypted with the public key of the source member entity, e.g., 106a. The source member entity, e.g. 106a decrypts the response. The source member entity, e.g., 106a, responds with its ESC, a challenge response and a challenge number encrypted using the target member entity's, e.g., 105b, public key.

This information is received, decrypted and the challenge response is verified by the target member entity, e.g., 105b. If the challenge response is correctly verified, the source member entity, e.g., 106a, is authenticated to the target member entity, e.g., 105b.

The target member entity, e.g. 105b, now sends its ESC with a challenge response to the source member entity e.g. 106a encrypted with the source member entity's, e.g., 106a, public key. The source member entity, e.g., 106a, verifies the challenge response received. If verified it authenticates the target member entity, e.g., 105b to the source member entity, e.g., 106a. Once the two entities are mutually verified the source member entity, e.g., 106a, accepts the MAC address of the target entity linked to its MAC address available in the ESC of the target member entity, e.g., 105b, and updates its address list. Similarly the target member entity, e.g., 105b, also updates its address list with the MAC address from the verified and authenticated ESC of the source member entity, e.g., 106a. This completes the secure and mutually authenticated ARP process.

At this point the entities are authenticated to each other using encryption and challenge numbers and by checking the individual ESC for trust worthiness. If authentication succeeded the IP to MAC contained in the ESC binding is accepted for updating the address list.

The ARP and RARP processes disclosed are mutually verifiable processes without any need for interaction with the administrative server. This enables the members of the SPG in the LAN 111 to verify and authenticate and link MAC address with IP address of the entities and securely update their address tables.

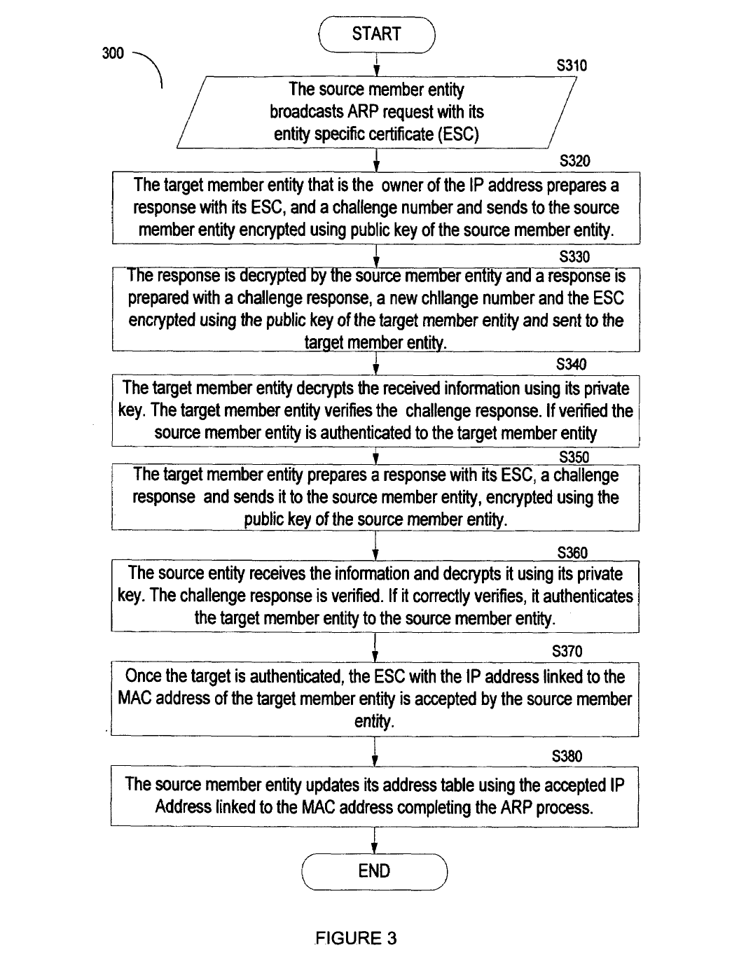

The ARP process for linking of IP addresses to MAC address of entities and updating the address lists of the entities, in accordance with the principles of the disclosed invention between pre-qualified peers of the SPG in a LAN 111 has the following exemplary and non-limiting steps shown in the flowchart 300 in FIG. 3:
An ARP request is broadcasted by a source member entity, e.g., 106a, with its ESC information (S310)
The target member entity, e.g., 105b, prepares a response with its ESC and a challenge number. This response is encrypted using the public key of the source member entity, e.g., 106a, and is sent to the source member entity, e.g., 106a, (S320);
The source member entity, e.g., 106a, receives the response, and decrypts the response using its private key. It prepares a response with its ESC, a challenge response and a new challenge number. This response is encrypted using the public key of the target member entity, e.g., 105b, and sent to the target member entity, e.g., 105b. (S330);
The target member entity receives the response, decrypts using its private key and verifies the challenge response. If verified it authenticates the source member entity, e.g., 106a, to the target member entity, e.g., 105b. (S340);
The target member entity, e.g., 105b now prepares a response with its ESC, the response to the challenge number and encrypts it using the public key of the source member entity, e.g., 106a. The encrypted information is sent to the source member entity, e.g., 106a. (S350);
The source member entity, e.g., 106a, receives the information and decrypts it using its private key. It verifies the response to the challenge number. If it is verified, the target member entity, e.g., 105b, is authenticated to the source member entity, e.g., 106a. (S360)
Once this is done the source member entity, e.g., 106a, based on the mutual authentication accepts the IP address linked to the MAC address, as detailed in the ESC, of the target member entity, e.g., 105b. (S370);
The address tables of the source member entity, e.g., 106a, are updated using the verified and linked IP to MAC address, completing the ARP process. (S380);

This completes the ARP process with mutual authentication of the two entities and updates and checks, of the address tables, for correctness at the source member entity e.g. 106a and the target member entity e.g. 105b. During the process if either the identification or the MAC address does not verify, then the process of discovery is terminated and the information of unauthorized intrusion is informed to the secure server 150 acting as administrative server for action based on security policies established.

Even though the disclosed invention is described for a LAN, other networks including but not limited to, wide area network (WAN), enterprise network, metro area network (MAN), and any combination thereof, may benefit from the teachings herein and hence the description is not intended to be limiting. The invention can be adapted for use with the Internet and other types of network and communication systems to improve the security. Such and other applications of the technology disclosed will be recognizable by individuals practicing the art and as such are covered by this disclosure.

What is claimed is:

1. A method for securing a network by a secure server by enabling secure dynamic host configuration protocol (DHCP) process by providing internet protocol (IP) addresses to member entities who are members of a secure peer group (SPG) within the network, where said secure server acts as a DHCP server.
